(19) United States
(12) Patent Application Publication
(10) Pub. No.: US 2017/0216774 A1
(43) Pub. Date: Aug. 3, 2017

(54) Batch Pressure-Driven Membrane Liquid Separation Using A Pressure Exchanger for Efficiency

(71) Applicant: Massachusetts Institute of Technology, Cambridge, MA (US)

(72) Inventors: David Elan Martin Warsinger, Potomac, MD (US); John H. Lienhard, V, Lexington, MA (US); Emily W. Tow, Cambridge, MA (US)

(73) Assignee: Massachusetts Institute of Technology, Cambridge, MA (US)

(21) Appl. No.: 15/296,688

(22) Filed: Oct. 18, 2016

Related U.S. Application Data
(60) Provisional application No. 62/288,588, filed on Jan. 29, 2016.

(51) Int. Cl. B01D 61/04; B01D 61/58; B01D 61/08; C02F 1/44; B01D 61/02

(52) U.S. Cl. CPC B01D 61/04; C02F 1/441; B01D 61/025; B01D 61/08; B01D 61/58; C02F 2103/08

(57) ABSTRACT

A source liquid including a solvent with a dissolved impurity flows into a reservoir. The source liquid or a concentration of the source liquid is pumped from the reservoir through a pressure exchanger into an upstream side of a liquid-separation module. The module includes a membrane that at least partially purified solvent as filtrate to a permeate side of the liquid-separation module while diverting the impurity in a feed retentate on the upstream side of the liquid-separation module. The substantially pure water is extracted from the permeate side of the liquid-separation module, while the feed retentate is passed from the upstream side of the liquid-separation module through the pressure exchanger, where pressure from the feed retentate is transferred to the feed from the reservoir. The feed retentate is then passed from the pressure exchanger to the reservoir and recirculated as a component of the feed via the above steps.

### RELATED APPLICATION

This application claims the benefit of U.S. Provisional Application No. 62/288,588, filed 29 Jan. 2016, the entire content of which is incorporated herein by reference.

### BACKGROUND

The demand for removing salt from brackish and saline waters continuous to increase, as water demand outstrips net rainfall for half the world's population, causing more reliance on groundwater withdrawal, seawater, agricultural water recovery, and potable water reuse. The fastest-growing technology used to meet these demands is reverse osmosis (RO), which is the most efficient technology for most water sources. Increasing RO energy efficiency is vital to reducing the operating cost and carbon intensity of desalination. While many research areas, such as membrane development, have reached diminishing returns in RO efficiency, there are still significant gains to be made in process design. Herein, we examine the efficiency improvements made possible by switching to time-variant RO systems and other systems for liquid mixture/solution separation.

### Reverse-Osmosis (RO) Desalination:

While RO is the most energy-efficient desalination process under most conditions, further improvements on efficiency are advantageous for minimizing the CO₂ impact of the energy requirements for RO, allowing for RO where power production is limited, reducing energy costs, and improving public acceptance of desalination.

Batch reverse osmosis technologies are configurations that vary their salinity over time by recycling brine. Batch technologies have also shown impressively robust resistance to membrane fouling, although an explanation for this is lacking from the literature. One of the most rapidly growing technologies is a semi-batch RO process, called CCRO, or closed circuit reverse osmosis (and trademarked as CCD, or closed circuit desalination).

### Closed Circuit Reverse Osmosis (CCRO):

Closed circuit reverse osmosis is a semi-batch process in which feed is continuously added to the system over time. In a CCRO system, feed water is pumped through the membrane module, where pure water passes through the membrane while the remaining solution is concentrated. The brine is then mixed with fresh, high pressure feed water and returned to the membrane module to be further concentrated. To account for this increasing concentration, the pressure of the system is increased over time. Once the desired amount of permeate has been produced, a valve is opened, and the system is refilled with feed in preparation for a new cycle. Several designs have been proposed historically in the patent literature for CCRO (U.S. Pat. Nos. 4,243,523, 4,814,086, and 4,983,301).

CCRO has potential advantages in terms of both fouling resistance and energy consumption. CCRO has been shown to be fouling resistant and has been tested to recoveries as high as 97%, although 88-92% is more typical. CCRO needs less energy than continuous RO because CCRO varies the pressure over time, which lets it stay closer to the osmotic pressure of the feed. In comparison, continuous RO sets the pressure everywhere above the maximum osmotic pressure of the outlet brine. However, one pitfall of CCRO is that it continuously mixes brine with incoming feed, which generates entropy and limits the efficiency of the process.

Past models of CCRO have modeled the process as a series of steady cycles with step pressure increases in between. This is a tolerable approximation for high recoveries (large numbers of cycles) with the cycles generally capturing the performance variation in time. However, these models do not capture the salinity profiles within the module. Furthermore, the discrete nature of the cycles prevents these from models from being used to study batch RO systems, which reach high recovery in few cycles. In order to improve accuracy and make a fair comparison to the batch process, we model CCRO as a temporally-and spatially-varying process that is modeled by numerically solving finely discretized equations, rather than a simple analytical model of a few cycles.

### Other Batch Configurations:

With respect to RO, the term “batch” has been used to indicate several configurations. Herein, “batch RO” signifies that RO brine is recirculated through the RO membrane module without incorporating any fresh feed. On the other hand, the term “closed circuit RO” is used to refer to configurations where RO brine is mixed with feed and re-circulated in a continuous manner, which is termed a “semi-batch” process due to the continuous feed addition. While the idea of a completely batch RO was proposed in U.S. Pat. No. 4,983,301, the concept was further developed more recently by various inventors. Oklejas proposed systems where the brine recirculation was integrated within the RO pressure vessel (U.S. Pat. No. 8,808,538). Batch RO systems have been reported to have problems maintaining permeate quality [R. L. Stover, “Industrial and brackish water treatment with closed circuit reverse osmosis,” 51 Desalination and Water Treatment 1124-1130 (2013)], so systems with variable feed pressure have also been proposed (see U.S. Pat. No. 7,892,429).

While several patent applications have been filed on batch RO, published studies on the modeling and performance of batch RO systems are limited. Barello conducted experiments on a batch RO process to study the influence of pressure and feed salinity on the water permeability constant of the membrane [M. Barello, D. Manca, R. Patel, and I. Mujtaba, “Operation and modeling of ro desalination process in batch mode,” Computers & Chemical Engineering; 2015]. Tarquin and Delgado reported that batch RO may be specially resistant to fouling and scaling based on experiments in which fouling was not observed even with brackish water under high concentrations of silica and calcium sulfates at 90% recovery [A. Tarquin and G. Delgado, “Concentrate enhanced recovery reverse osmosis: a new process for RO concentrate and brackish water treatment,” Proc. American Institute of Chemical Engineers Meet., Pittsburg, Pa., USA, October, American Institute of Chemical Engineers, Paper 272277 (2012)].

Membrane fouling can lead to declining flux, increasing stream-wise pressure drop, and changes in salt permeation. These changes in turn affect water cost through pretreatment requirements, increased energy consumption, frequent membrane cleanings, and eventually membrane replacement. Resistance to fouling of various types, including inorganic, organic, and biological, is thus a common theme in desalination research.

Inorganic fouling, or scaling, is of particular importance in low salinity water desalination. Khan, et al., in “How different is the composition of the fouling layer of wastewater reuse and seawater desalination RO membranes?,” 59 Water Research 271 -282 (2014), harvested foulant layers from RO membranes used to treat seawater and secondary wastewater effluent in a pilot plant, and found that, although organic foulants dominated in seawater RO and on the first membrane of wastewater RO, inorganic foulants comprised 88.9% by mass of the foulant layer on the last membrane in the wastewater RO train. The high degree of brine concentration due to the high recovery typical of low-salinity water desalination tends to concentrate inorganic foulants, such as calcium carbonate, to beyond their saturation limits, causing scale on the later membranes.

The susceptibility of RO membranes to damage by fouling has prompted the development of other processes, such as membrane distillation and forward osmosis, which are thought to exhibit greater resistance to fouling. However, the higher efficiency of RO makes it worthwhile to consider modifications to the RO process that could lead to improvements in fouling resistance. Stover has proposed that CCRO can reduce fouling and scaling through the time-variation of water composition at the membrane [R. Stover, “Evaluation of closed circuit reverse osmosis for water reuse,” in Proc. 27th Annual Water Reuse Symp., Hollywood, Fla., USA, September, Water Reuse Association, Paper B4-2(2012)]. Herein, we examine the cycle time of CCRO as well as batch operation to identify potential gains in scaling resistance through these time-variant RO processes.

### SUMMARY

Methods and apparatus for batch liquid separation using a pressure exchanger are described herein, where various embodiments of the apparatus and methods may include some or all of the elements, features and steps described below.

In a method for batch pressure-driven liquid separation, a source liquid including a solvent with a dissolved impurity is flowed into a reservoir. The source liquid or a concentration of the source liquid is pumped from the reservoir through a pressure exchanger into an upstream side of a liquid-separation module. The liquid-separation module includes a membrane that passes at least partially purified solvent as filtrate to a permeate side of the liquid-separation module while diverting the impurity in a feed retentate on the upstream side of the liquid-separation module. The purified solvent is extracted from the permeate side of the liquid-separation module, while the feed retentate is passed from the upstream side of the liquid-separation module through the pressure exchanger, where pressure from the feed retentate is transferred to the feed from the reservoir. The feed retentate is then passed from the pressure exchanger to the reservoir and recirculated as a component of the feed via the above steps, wherein the concentration of the impurity in the feed and pressure in the upstream side of the liquid-separation module increases and volume of feed in the reservoir decreases with each iteration of the steps. After a plurality of iterations, a concentrated impurity stream is discharged from the liquid-separation module; and new source liquid is supplied to the reservoir.

The liquid-separation module can be a reverse-osmosis module, a nanofiltration module (e.g., using a membrane with 1-10-nm sized through-pores), or other kind of liquid-separation module.

Improving membranes, controlling fouling, designing efficient components, and developing improved system configurations are all important parts of the effort to approach 100% exergetic efficiency in desalination. Apparatus and methods described herein can provide a system configuration for higher efficiency through the design of a recirculating batch reverse osmosis (RO) process that utilizes only existing components.

The RO batch processes described herein may be used prevent nucleation of salt crystals and biofouling. Many applications require higher recovery for RO, as this reduces costs by minimizing pretreatment of unused feed and water waste. Furthermore, a trend in environmental legislation mandates for zero-liquid-discharge (ZLD) to reduce pollution from brine waste is requiring many applications to use higher recoveries. These trends also render advantageous the batch RO apparatus and methods described herein, which can achieve higher recovery than achievable with continuous processes. Notably, batch processes and apparatus may be scaled to smaller sizes than current systems, as the batch apparatus can achieve high recovery with a single membrane module.

### BRIEF DESCRIPTION OF THE DRAWINGS

FIG. 1 is a schematic illustration of a multi-stage train of reverse-osmosis (RO) modules for high recovery of purified water, as individual modules typically cannot recover more than approximately 50% each.

FIG. 2 is a schematic diagram of a closed-circuit reverse osmosis (CCRO) system. Feed continuously enters the system; but brine is rejected only at the end of the cycle, and pressure in the system gradually increases over time. The brine is rejected from the system only between cycles.

FIG. 3 is a schematic diagram of a batch design for RO, resembling CCRO but with a variable-volume tank (as described in U.S. Patent Application No. 62/298,009); and feed is added to the tank only in the first pass. In this embodiment, a pressure exchanger is used to reduce the pressure in the retentate recirculated back to the tank, so a variable-volume high pressure tank need not be invented.

FIG. 4 illustrates volume discretization of a membrane module for batch and CCRO models. The membrane module is divided into unequal volumes. In each step, equal amounts of permeate are removed from each section; and the remaining liquid moves to the next section.

FIGS. 5 and 6 chart salinity profiles in a membrane module as recovery increases during each cycle for (a) the CCRO process (FIG. 5) and (b) the batch process (FIG. 6) with 3 g/kg salinity at 75% water recovery. The abscissa, which represents dimensionless distance, is defined as the fraction of the module recovery achieved as the fluid traverses the module (equivalently, i/n). Lines are equally spaced by permeate production, and the arrows indicate the direction of cycle progression.

FIG. 7 plots the modeled energy consumption of steady and time-variant RO configurations for various recovery ratios with 3 g/kg NaCl feed. The least work of separation is also shown.

FIG. 8 plots the exergetic efficiency (in %) for RO, CCRO, and batch systems.

FIG. 9 plots the percent reduction in energy requirements of (a) a CCRO system and (b) a batch RO systems compared to continuous RO.

FIGS. 10 and 11 plots minimum pressure vs. instantaneous recovery ratio for steady RO, constant volume RO (e.g., CCRO), and batch RO processes for 3 g/kg NaCl feed and recovery ratios of 45% (FIGS. 10) and 85% (FIG. 11).

FIG. 12 schematically illustrates a derivative configuration with multiple systems in parallel.

In the accompanying drawings, like reference characters refer to the same or similar parts throughout the different views; and apostrophes are used to differentiate multiple instances of the same or similar items sharing the same reference numeral. The drawings are not necessarily to scale; instead, an emphasis is placed upon illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures and phenomena described below can occur at ambient pressure (e.g., about 50-120 kPa—for example, about 90-110 kPa) and temperature (e.g., −20 to 50° C—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

As noted, above, the apparatus and methods described herein can be used in any of a variety of liquid-separation systems, though for purposes of exemplification, various aspects of the invention will be discussed in the context of an RO system.

For the RO systems described herein, energy recovery refers to methods to recovery energy, e.g., in the form of electricity, from high pressure liquid. This is often done with a turbine, or other variants of a high pressure fluid doing mechanical work on a device connected (e.g., with shafts, levers) to a generator.

For these systems, pressure recovery refers to the use of one high pressure fluid to pressurize another, thus saving energy. It is often done when high-pressure fluid is being rejected to atmosphere, and the potential to do work with this stream would otherwise be wasted. This avoids simply throttling the fluid and can achieve a higher efficiency than an energy recovery device powering a pump.

Several types of devices may be used for pressure recovery. These include rotary pressure exchangers (such as those produced by Energy Recovery, Inc., of San Leandro, Calif., USA); pressure recovery pumps; systems with turbines, as described in the next paragraph; and piston systems, such as a piston double chamber with a hydraulically driven pump and reciprocating design (e.g., a dual work exchanger energy recovery (DWEER) device). The system can use a pressure exchanger only to exchange pressure between the retentate from an RO module and the feed entering that module (or a different module). Moreover, the pressure exchanger can be modified to optimize for widely variable pressures. This modification may include changes in size of ducts, an overall increase in the size of the pressure exchanger, providing the ability to shut off certain holes for fluid passage through the pressure exchanger at different pressures, etc. A valve blocking off the pressure exchanger can also be provided so that flow does not leak from feed to permeate once shutdown between batches occurs. This valve may be actuated or a passive directional valve, such as a check valve, can be used. Components to alter the speed of rotation of the pressure exchanger (for a rotary pressure exchanger) can also be provided. Given the frequency of shutdown, a motor (such as a variable-frequency-drive motor) can be added to periodically start the pressure exchanger rotation. Brakes can be added to the pressure exchanger, as well. To aid in startup of the pressure exchanger, some of the flow channels can be curved instead of straight-flow ducts to enhance torsional forces as water flows through (e.g., a corkscrew-shaped flow path that causes rotation of the water can be used—as water rotates, it will exert torque on the pressure exchanger, causing it to rotate as well.

One exemplification of an energy-efficient batch process uses an atmospheric or near-atmospheric pressure tank in a circulation loop with the RO membrane module, while recovering the energy from the circulating fluid during depressurization through energy recovery or pressure recovery. In particular embodiments, the pressure exchanger further acts as an energy-recovery system, wherein the high-pressure retentate has its pressure reduced through a pressure exchanger that operates as an energy recovery device, including, e.g., a turbine that converts the change in enthalpy into electrical work. Then, the feed is re-pressurized by converting that electrical work back into a pressure increase in the feed (e.g., by powering a pump) before the feed passes back through the membrane module. This system can be designed in a flow loop that comprises a high-pressure pump for inlet water, one or more membrane modules, an energy recovery device after the modules, a tank for brine storage, and a connection back to the inlet of the module. The system can also have additional fluid pathways for intake and for rejection that are activated, e.g., by controllable valves (the valves in the system can be, e.g., manually, spring, electrically, pneumatically, or hydraulically actuated valves).

Alternatively, the system can use a pressure recovery device (or “pressure exchanger”) instead of an energy recovery device. These devices transfer pressure from one stream to another and may be thought of as a “heat exchanger” for pressure. These devices tend to be much more efficient than energy-recovery devices. However, most have the following limitation: they need equal flow rates between the pressure-exchanging streams. Batch systems are constantly changing volume, and the only variable-volume component is the tank, the volume of which decreases over time. The stream being pressurized, therefore, always has a larger volume than the stream being depressurized, so a bypass stream with a high-pressure pump is utilized. The pressure exchanger is not 100% efficient, so a booster pump can be utilized after the pressure exchanger. This system can be designed in a flow loop comprising the following: a high-pressure pump for inlet water, one or more RO membrane modules, a pressure exchanger for pressure recovery after the modules, high-pressure and booster pumps to support the pressure exchanger, a reservoir for feed storage, and a connection back to the inlet of the RO module. The system can also have additional fluid pathways for intake and for rejection, and flow through those pathways can be activated by electrically actuated valves.

Other types of pressure-recovery devices may alternatively be used, including pumps with integrated pressure recovery, e.g., utilizing a piston design. Centrifugal and circulation pumps may also be designed for use with a joined or separate pressure exchanger.

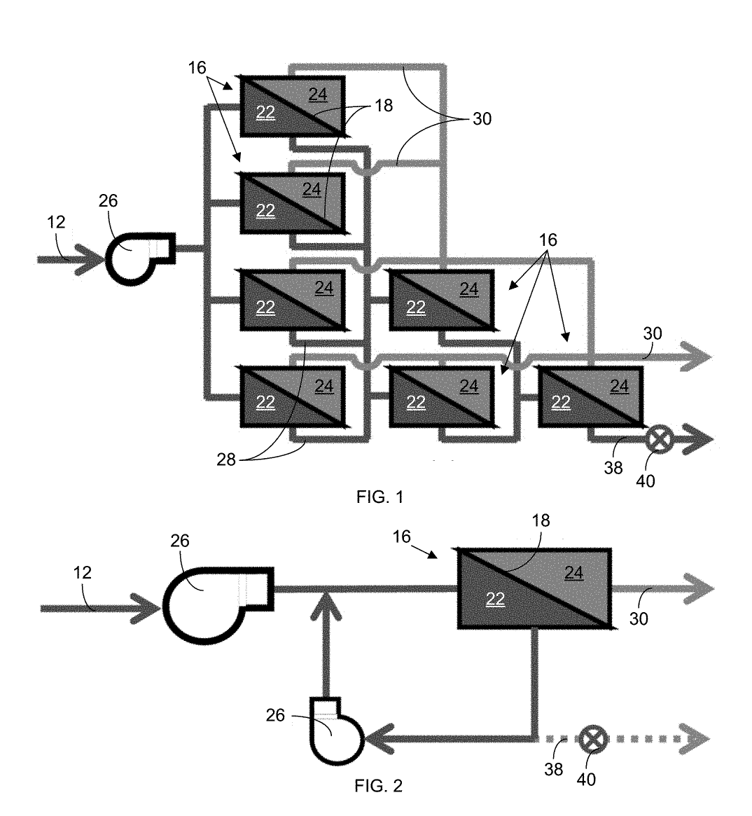

Particular embodiments utilize a plurality of multi-stage RO modules, where the feed flows from one or more reservoirs 14 (as shown in FIG. 12) through a plurality of RO modules 16, and wherein the retentate from early stage modules 16 is fed as the feed into later-stage modules 16 (from left to right, as shown in FIG. 1). Multi-stage designs can be further implemented by having the retentate loop 34 in one stage exchange pressure with the feed in another loop 32 that isn't as far along in the cycle, and is thus at lower pressure. This can eliminate the need for the booster pump 26″. If sizes are varied with the larger system first, then many of the intermediary stages can have their primary pumps 26′ eliminated, and simply match flow rates of their retentate outlet with the feed inlet of the previous loop. This saves costs and reduces the number of components but reduces the degree of pressure control and utilizes a large number of pressure exchangers 20.

Nomenclature used herein is defined, below, to facilitate understanding.

### NOMENCLATURE

i Section number within membrane module [-]
m Mass [kg]
n Number of sections in discretized membrane module [-]
N Number of stages [-]
Nₚₐₛₛ Effective number of times a the volume of feed is recirculated [-]
RR Recovery ratio [-]
RRₘ Module recovery ratio [-]
s Salinity [g/kg]
tₚₐₛₛ time for a fluid element to pass through the RO module [s]
t_{ind} induction time for crystal nucleation [s]
V Volume [m³]
\dot{V}Volume flow rate [m³/s]
w Specific energy consumption [J/kg permeate]
ΔPₗ Viscous pressure drop per stage [Pa]
ΔPₜ Terminal hydraulic-osmotic pressure difference [Pa]
ΔV_{P} Permeate volume produced in one step [m³]
η 2^{nd} law efficiency [-]
π Osmotic pressure [Pa]
Q Density [kg/m³]

### Subscripts:

B Booster pump
b Brine
C Circulation pump
ERD Energy recovery device
f Feed
H High pressure pump
i ith section of membrane
j jth permeate removal step
m module
n Last section of membrane
p Permeate
PX Pressure exchanger
R Energy recovery device
s Salt
t Tank
w Water

### Modeling Methods:

The following methodology relating to this invention is adapted from D. Warsinger, et aL, “Energy efficiency of batch and semi-batch (CCRO) reverse osmosis desalination”, to be published in Water Research..

Energy models are developed for three RO process types in order to enable comparisons between them. To make the comparisons fair, design parameters, such as pump efficiency are kept the same between models. Rather than developing detailed mass transfer models for all three systems, the driving force for water flux at the brine outlet is kept constant as a proxy for fixing the membrane area. The energy consumption of the three RO process types are then compared across a range of feed salinities and recovery ratios.

### System Comparisons:

System comparisons are made at a fixed recovery ratio, RR, which is defined as the fraction of feed water recovered as permeate. For a continuous system,

$$RR = \frac{{\dot{V}}_{p}}{{\dot{V}}_{f}} ; \qquad ( 1 )$$

and, for a batch or semi-batch system,

$$RR = \frac{{V}_{p , cycle}}{{V}_{f , cycle}} . \qquad ( 2 )$$

Here, \dot{V}_{f} and \dot{V}ₚ are the volume flow rates of feed and permeate, respectively, in a continuous RO system, while V_{f,cycle} and V_{p,cycle} are the total volumes of feed consumed and permeate produced in each cycle of a batch or semi-batch process.

In addition to RR, several other variables are held constant across all systems considered. The module recovery ratio, RRₘ, is fixed and is defined as the fraction of feed entering the membrane module that leaves as permeate in a single pass. The feed solution varies widely between water sources, though the methods and apparatus described herein can be used with a wide variety of other water sources. For the purpose of this comparison, however, feeds will be represented by sodium chloride solutions for the example processes presented herein. Solution osmotic pressure is calculated at 20° C. using the Pitzer model for electrolyte solution properties [see, e.g., K. S. Pitzer, “Thermodynamics of electrolytes. I. Theoretical basis and general equations,” 77 The journal of Physical Chemistry, 268-277 (1973)]. All pump efficiencies are fixed at 75%. Although pretreatment energy consumption can be a significant fraction of the total in low-salinity applications, it is left out of this analysis because it would likely be similar for all systems. For the purpose of this energetic comparison, salt permeation is neglected; and, thus, the permeate osmotic pressure is assumed to be zero. Finally, to ensure sufficient flux, all models are based on a fixed terminal osmotic—hydraulic pressure difference, ΔPₜ, equal to the difference between pressure and osmotic pressure at the brine outlet.

### Steady RO Configuration:

Steady RO is simple to model because it is time-invariant. FIG. 1 shows a steady RO system for producing purified water 30 and a concentrated brine 38, including a feed pump 26 and a train of RO modules 16, each including a membrane 18 that rejects a high fraction of dissolved ions. Reverse osmosis membranes are nanoporous or nonporous membranes that pass water but reject a large fraction of dissolved solutes, particularly those that are charged, as well as larger colloidal, suspended, and particulate matter and microorganisms. RO membranes are typically polymeric (thin-film composites or asymmetric single polymers) but can be made of other nanoporous materials, such as graphene or carbon nanotubes.

Neglecting salt permeation through the membrane 18, the salinity (as salt mass fraction) can be calculated with Eq. (3) from steady salt continuity as follows:

$${s}_{b} = \frac{{s}_{f}}{1 - RR} , \qquad ( 3 )$$

where s_{b} and s_{f} are the brine and feed salinities, respectively.

The specific energy consumption, w_{RO}, of the simple RO system without booster pumps or energy recovery can be expressed as follows:

$${w}_{RO} = \frac{{π}_{b} + Δ {P}_{t} + N Δ {P}_{1}}{{η}_{p} RR} , \qquad ( 4 )$$

where N is the number of stages needed to reach a recovery ratio of RR with a per-module recovery of RRₘ; π_{b} is the brine osmotic pressure; ΔPₗ is the viscous pressure drop per module; and ηₚ is the pump efficiency. In practice, N would be rounded to a whole number; and the module size or applied pressure would be adjusted to achieve the desired recovery ratio. However, for the purpose of this system comparison at constant RR and RRₘ, non-integer numbers of stages are allowed. The theoretical number of RO stages is calculated from the following expression,

1−RR=(1−RRₘ)^{N},

which represents that the feed volume is reduced by a factor of 1−RRₘ, in each stage 16 to an eventual volume of 1−RR times the initial volume. Replacing the brine throttle with an energy recovery device (70% efficiency assumed) lowers RO energy consumption somewhat:

$${w}_{RO + ERD} = \frac{{π}_{b } + Δ {P}_{t} + N Δ {P}_{l}}{{η}_{p} RR} - \frac{( {π}_{b} + Δ {p}_{t} ) ( 1 - RR ) {η}_{ERD}}{RR} , \qquad ( 6 )$$

where η_{ERD} is the energy recovery device efficiency.

A closed circuit reverse osmosis system is shown in FIG. 2. The aqueous source liquid 12 continuously enters the system, but brine 38 is only rejected only at the end of the cycle. Pressure gradually increases over time. Dotted lines (for the brine 38) represent flows present only between cycles.

### Batch Configuration:

Entropy generation due to mixing of fresh aqueous source liquid 12 with recirculated retentate in CCRO systems can be minimized through a fully batch process. In each cycle of such a process, the feed of source liquid enters only at the beginning of a cycle. The retentate from the RO module is circulated and concentrated over time and then exits the system.

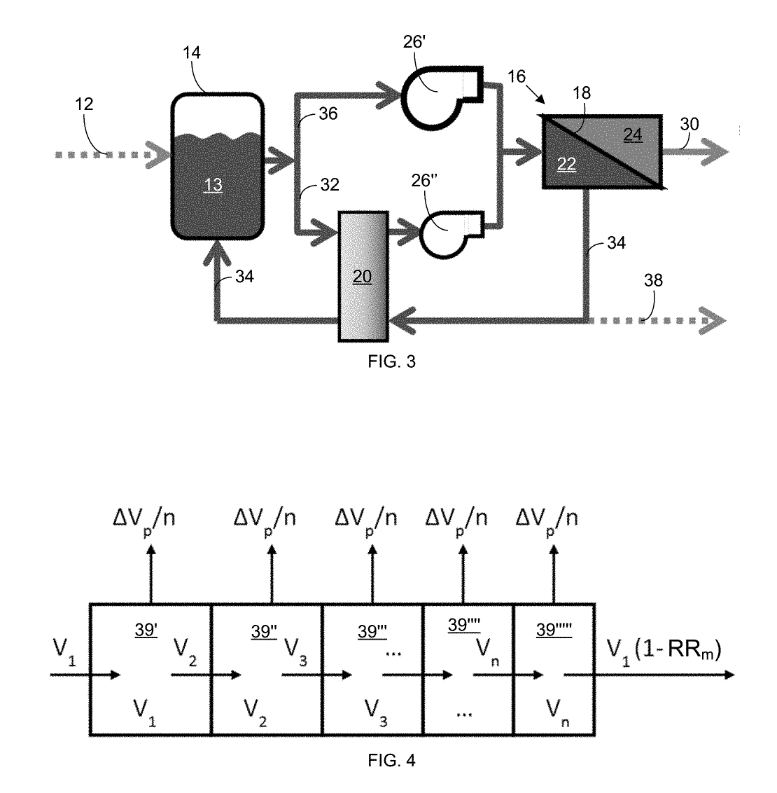

A batch process designed using only existing components, including an atmospheric pressure tank 14 and a pressure exchanger 20, is shown in FIG. 3. The batch process cycles the applied pressure on the membranes in order to improve energy efficiency, as well as to optimize permeate flux and maintain antifouling characteristics.

At the beginning phase of the process, the reservoir 14 is filled (by opening an actuated valve in fluid communication with a liquid source) with new aqueous source liquid 12. The feed 13 from the reservoir 14 then proceeds to the pressurizing pumps 26 (and pressure exchangers 20) for pressurization. Some liquid passes through the main high-pressure pump 26′ to maintain equal flow rates through the pressure exchanger 20. Typically, if a pressure exchanger 20 is used, a make-up pump 26″ will finish pressurization until the pressure in the RO module 16 is reached. Next, the flow of the feed 13 proceeds through the RO module(s) 16. After exiting the RO module 16, the flow of the retentate 22 from the module 16 is directed back to the reservoir 16. The pressure in the RO module 16 increases over time as the salinity in the feed 13 increases. The most efficient methodology from the standpoint of the flow loop is to gradually increase pressure as salinity increases. The necessary pressure will be a function of the osmotic pressure, plus additional excess pressure to overcome viscous losses and improve permeate flux. In particular embodiments, a variable-frequency-drive (VFD) pump can be used to vary the pressure of the feed 13. As an end step, a valve is opened to release permeate 30; and the pressure of pumping is reduced.

Optionally, an osmotic backwash of the membrane 18, can be performed by reducing the pressure of the feed 13 on the upstream side of the membrane 18 below the pressure on the permeate side of the membrane 18. Backwashing with osmotic pressure has proven extremely effective in eliminating fouling in RO systems. In such a process, the osmotic pressure of the saline (retentate) side exceeds that of the applied pressure, causing permeate to flow back from the permeate side to the retentate side.

Osmotic backwashing can be seamlessly incorporated into batch and semi-batch systems with the following methodology for pressure control. This procedure is performed by one or more pressure setpoints on the pumps, specific valves, and backpressure and other pressure regulators. For example, a pressure sensor in the flow path can communicate (when a setpoint is triggered) with a controller that changes the pump flow rate and also opens/closes the valve(s) at certain points in the cycle. The principle behind osmotic backwashing is a reduction of the pressure of the saline stream sufficient so that it no longer counteracts the full osmotic pressure of that salinity, causing pure permeate to flow in the opposite direction through the membrane, backflushing as it flows towards the feed side from the permeate side.

In one embodiment of osmotic backwashing in batch systems, the batch system completes a cycle, where the salinity of the feed 13 is sufficiently high that the reservoir 14 needs to be purged. The applied pressure of the feed/retentate loop is decreased by stopping pumping, typically combined with opening a release valve for outflow from this loop. This release valve (e.g., a butterfly valve) may be variable-volume to allow very little feed 13/retentate 22 to leave. One way to decrease the pressure is to open a valve in the high-pressure part of the loop, another is to decrease the pumping pressure setpoint of the pumps. The feed 13 is now at low pressure, causing permeate 24 to go back through the membrane 18 from osmotic pressure. Note that the permeate valves are open such that permeate may flow back freely. As water is incompressible, a flow path with variable volume is provided. This variable-volume flow path can be achieved via a piston system, bladder, or simply a tank/reservoir exposed to atmosphere that has a volume that can vary. An alternative to this approach is frequent backwashing, where periodically the pump pressure is decreased but then increased again to resume the cycle.

### Batch and CCRO Modeling:

Because of their similarity, batch RO and CCRO are discussed together in this section.

Unlike the steady RO model, which requires no discretization, both batch and CCRO models employ discretization because the salinity of the feed 13 varies in both space and time. The temporal variation can be addressed by dividing the CCRO process into a number of cycles, each of which appears to be modeled as standard (time-invariant) RO at a recovery ratio equal to the module recovery ratio, as described in R. L. Stover, “Permeate recovery and flux maximization in semibatch reverse osmosis,” 5 IDA Journal of Desalination and Water Reuse, 10-14 (2013), and in R. Stover, “Evaluation of closed circuit reverse osmosis for water reuse,” in Proc. 27th Annual Water Reuse Symp., Hollywood, Fla., USA, September, Water Reuse Association, Paper B4-2(2012). Terminal osmotic pressure is calculated for each cycle and pressure is increased at the beginning of each cycle. In a real batch or CCRO system, feed pressure can be gradually and continuously increased during each cycle as the feed is concentrated; and terminal osmotic pressure may be lower than that predicted with steady-state assumptions. The model employed in this study should more accurately capture both temporal and spatial evolution of concentration, which is particularly relevant to energy consumption for low recovery ratios in CCRO and for all batch cases.

A discretization method was chosen to simplify modeling based on the assumption of fixed terminal hydraulic-osmotic pressure difference, ΔPₜ. If we assume a fixed ΔPₜ, as in the steady RO model, the process can be discretized by permeate produced. During each step forward, a small amount of permeate is removed from each subdivision of the RO module 16; and the water and salt remaining in each section move to the next section. This ensures that by the time a parcel of feed 13 moves from the beginning to the end of the module 16, its volume has been reduced by a factor of (1−RRₘ), where RRₘ, is the module recovery ratio.

Because the volume of feed 13 is reduced in each step, the RO module 16 is discretized into unequal volumes, as shown in FIG. 4, according to Eqs. (7)-(10). Each section 39′-39′″″ is ΔVₚ/n larger than the section that follows it because of the removal of permeate in each step. For an odd number of sections, n, the total module volume, Vₘ, can be related to the first section volume, V₁, as follows:

$${V}_{m} = {\sum }_{i = 1}^{n} {V}_{i} = {nV}_{\frac{n - 1}{2}} = n ( {V}_{1} - \frac{n - 1}{2} \frac{Δ {V}_{p}}{n} ) . \qquad ( 7 )$$

The permeate volume removed in each step, ΔV_{P}, is the sum of the permeate volumes removed from all of the sections 39′-39′″″ during one step, while V₁ is the volume of feed 13 entering the RO module 16 during the same step. Therefore,

ΔVₚ=V₁RRₘ. (8)

Because permeate is removed from the solution as it traverses the module 16, the discretized volumes are unequal. Equations (7) and (8) can be combined into Eq. (9) for the volume of the first section 39′,

$${V}_{1} = \frac{{V}_{m}}{n - \frac{{RR}_{m} ( n - 1 )}{2}} , \qquad ( 9 )$$

and the volume of the ith section is as follows:

Vᵢ=V₁−iΔVₚ. (10)

In addition to the module volume, the batch system also has a variable-volume tank (reservoir) 14, the initial volume of which is calculated before beginning to advance time. To reduce the cost of the reservoir 14, its size can be minimized as follows: for the batch system, the reservoir 14 and RO module 16 begin filled with feed 13; at the end of the cycle, a minimally sized reservoir 14 would be empty; and the membrane module 16 and piping are purged of brine 38. Therefore, the volume of feed 13 in the RO membrane module 16 plus piping is equal to the brine volume for one cycle; and the volume of the reservoir 14 is equal to the permeate volume. Neglecting the volume of piping (in comparison to the module volume), the volumes of the RO module 16 (Vₘ) and the reservoir (tank) 14 (Vₜ) can be related by the following equation:

$$\frac{{V}_{m}}{{V}_{t}} = \frac{1 - RR}{RR} . \qquad ( 11 )$$

Next, the calculation of salinity is described within the module 16 over time. As water moves between sections 39′-39′″″, salt mass is conserved while water mass is reduced by ρ_{P}ΔVₚ, where ρₚ is the pure water density. Changes in density due to the gradual concentration of the feed 13 are neglected, as density increases by less than 1% for most of the salinity and recovery ratio range considered here. The osmotic pressure at the end of the RO module 16, πₙ, is calculated from the salinity of the last section.

If we allow jto denote the permeate production step number (j=Vₚ(t)/ΔVₚ), then the salt and water masses (m_{s,i,j}and m_{w,i,j}, respectively) in the ith section can be calculated as follows:

$$\begin{matrix}{m}_{s , i , j} = \{ \begin{matrix}{s}_{1 , j} {V}_{1} {ρ}_{f} & i = 1 \\ {m}_{s , i - 1 , j - 1 } & i \neq 1\end{matrix} and & ( 12 ) \\ {m}_{w , i , j} = \{ \begin{matrix}( 1 - {s}_{1 , j} ) {V}_{1} {ρ}_{f} & i = 1 \\ {m}_{, i - 1 , j - 1} & i \neq 1\end{matrix} . & ( 13 )\end{matrix}$$

These conservation equations result from the salt moving from section to section, and the water moving with it except for the portion removed as permeate from each section in each step. The local salinity, s_{i,j}, can then be calculated as the salt mass fraction, as follows:

$${s}_{i , j} = \frac{{m}_{s , i , j}}{{m}_{w , i , j} + {m}_{s , i , j}} ; \qquad ( 14 )$$

and the maximum osmotic pressure in the RO module 16 can be calculated using the Pitzer model [K. S. Pitzer, “Thermodynamics of electrolytes. I. Theoretical basis and general equations,” 77 The journal of Physical Chemistry, 268-277 (1973)] based on the salinity in the last section, as follows:

π_{n,j}=π|ₛ_{_{n,j}}. (15)

The method of calculating the salinity of the solution entering the RO module 16 over time is different between the batch and CCRO processes. For the batch process, the concentrate leaving the RO membrane module 16 is mixed with the solution in the reservoir 14. Equations (16) and (17) are salt and water mass balances, respectively, governing time-progression of salinity in the discretized model for the batch process:

m_{s,t,j}=m_{s,t,j-1}+m_{s,n,j-1}−m_{s,1,j-1}, and (16)

m_{w,t,j}=m_{w,t,j-1}+m_{w,n,j-1}−m_{w,1,j-1}. (17)

The salinity of the first section of the RO membrane module 16, s_{1,j}, is then the salt mass fraction of the reservoir 14 at step j.

For the CCRO process, the aqueous source liquid is continually mixed with the concentrated retentate to maintain a constant system volume as permeate is removed. Because the make-up feed flow rate into the system is equal to permeate flow rate, the following salt and water balances can be applied at the mixing junction:

m_{s,1,j}=m_{s,n,j-1}+Vₚρ_{f}s_{f}, and (18)

m_{w,1,j}=m_{w,n,j-1}+(1−s_{f})Vₚρ_{f}. (19)

In both processes, the module is completely filled with feed in the initial state of the cycle, giving the conditions everywhere at i=1. This neglects stream-wise mixing between the incoming feed and outgoing brine at the end of the cycle as well as any transport of water across the membrane during the time it takes to refill the module with feed. With this initial condition, the model has been described to the extent where salinity profiles can be calculated for the batch and CCRO processes.

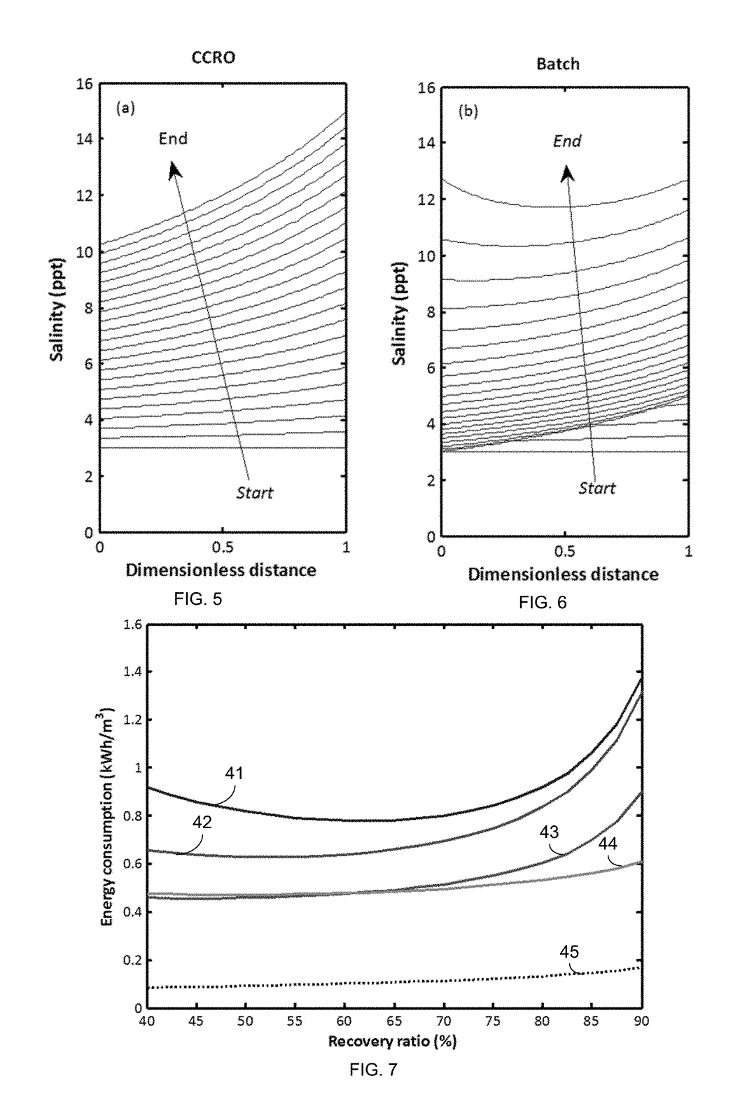

FIGS. 5 and 6 shows example salinity profiles for CCRO and batch systems, respectively, to illustrate the differences between these seemingly similar processes. These profiles are based on a feed salinity of 3 g/kg at 75% recovery. The abscissa, dimensionless distance, is defined as the fraction of the module recovery achieved as the fluid traverses the module (equivalently, i/n). Lines are equally spaced by permeate production; arrows indicate the direction of cycle progression.

In both processes, salinity increases everywhere as the cycle progresses. As in steady RO, the CCRO salinity profile is monotonically increasing with distance at any given time. However, batch RO departs from this behavior as each cycle approaches its end. Although each parcel of fluid increases in salinity as it traverses the RO module 16, the spatial salinity profile in the RO module 16 can have a minimum in the middle of the RO module 16. This profile occurs because concentrated retentate 22 from the outlet of the RO module 16 returns to the reservoir 14 and then added to the feed 13. Near the end of the cycle, the volume of the feed 13 in the reservoir 14 is almost zero, so concentrated retentate 22 goes almost directly from the outlet of the RO module 16 back to the inlet of the RO module 16, causing the difference between inlet and outlet salinities to approach zero at each cycle's end. The energetic implications of this unusual salinity profile is discussed, infra. Next, expressions for energy are provided based on the salinity progressions calculated with the models described above.

Once the salinity at the end of the RO membrane module 16 is calculated using the above model, the pressure at the module outlet is set to a fixed amount above the osmotic pressure of the last section of the RO membrane module 16; the feed 13 entering the inlet of the RO module 16 is then pumped in at the current osmotic pressure in the last section plus the terminal osmotic pressure difference and the hydraulic pressure drop through the RO module 16. Pressure drop through the RO module 16 due to viscous losses is estimated to be 1 bar.

The energy consumption of the brine rejection step is assumed to be equal in the CCRO and batch processes, although the actual energy consumption will depend somewhat on the system design. As discussed above, various methods have been proposed for emptying the RO module of brine 38 and refilling it with feed 13. The choice of method largely affects the area requirement of the membrane 18, while the energy consumption is not significantly affected so long as brine 38 is discharged at atmospheric pressure. In these models, a brine reject valve 40 is opened, and feed 13 is pushed into the RO module 16 at roughly atmospheric pressure, displacing the brine retentate 22. Assuming negligible back-flux of permeate 24 during the brine rejection step, the specific energy consumption of brine rejection, w_{brine-rejection}, is modeled based on the pressure loss through the RO module 16, API, as follows:

$${w}_{brine \text{-} rejection} = \frac{1 - RR}{RR} Δ {P}_{1} . \qquad ( 20 )$$

The reversible work done by each pump 26 is the volume flow rate integral of the pump pressure. The total work done by the pumps 26 is then the sum of the reversible work contributions of each pump 26 divided by its efficiency. In the discretized model, the integral is approximated by a sum.

In the case where the reservoir 14 is at atmospheric pressure and where a pressure exchanger 20 is utilized, some energy is lost in depressurization and pressurization. Modeling the pressure exchanger 20, as described in K. H. Mistry, R. K. McGovern, G. P. Thiel, E. K. Summers, S. M. Zubair, and J. H. Lienhard V, “Entropy Generation Analysis of Desalination Technologies,” 13 Entropy 1829-1864 (2011), at an efficiency of η_{PX}=96%, the energy consumption per unit permeate 24 of the batch process with an atmospheric pressure reservoir 14, w_{batch,LP}, is:

$${w}_{batch , LP} = \overbrace{\frac{Δ {V}_{P} {\sum }_{j = 1}^{{V}_{p} / Δ {V}_{p}} ( {π}_{n , j} + Δ {P}_{t} + Δ {P}_{1} )}{{V}_{p} {η}_{p}}}^{high pressure pump work} + \overbrace{\frac{1 - {RR}_{m}}{{RR}_{m}} \frac{Δ {V}_{P} {\sum }_{1}^{{V}_{p} / Δ {V}_{p}} ( {π}_{n} + Δ {P}_{t} + Δ {P}_{1} - {η}_{PX} ( {π}_{n} + Δ {P}_{t} ) )}{{V}_{p} {η}_{b}}}^{booster pump work due to irreversible pressure exchange} + \overbrace{\frac{1 - RR}{RR} \frac{Δ {P}_{1}}{{η}_{p}}}^{brine ejection} , \qquad ( 21 )$$

where ηₚ and η_{b} are the efficiencies of the high pressure and booster pumps.

In CCRO, the energy requirement per unit permeate 24, w_{CCRO}, is the feed volume integral of feed pressure (or, in this discretized case, a sum) plus the contributions from viscous losses during recirculation and brine ejection:

$${w}_{CCRO} = \overbrace{\frac{Δ {V}_{p} {\sum }_{j = 1}^{{V}_{p} / Δ {V}_{p}} ( {π}_{n , j} + Δ {P}_{t} + Δ {P}_{l} )}{{V}_{p} {η}_{p}}}^{high pressure pump work} + \overbrace{\frac{1 - {RR}_{m}}{{RR}_{m}} \frac{Δ {P}_{l}}{{η}_{c}}}^{circulation pump work} + \overbrace{\frac{1 - RR}{RR} \frac{Δ {P}_{l}}{{η}_{p}}}^{brine ejection} . \qquad ( 22 )$$

Batch and CCRO results are based on Eqs. (21) and (22) with the module divided into 101 sections (n=101). In the absence of batch RO or CCRO experimental data, validation of these models will rely on comparison with the reported results of the CCRO model by Stover [R. Stover, “Evaluation of closed circuit reverse osmosis for water reuse,” in Proc. 27th Annual Water Reuse Symp., Hollywood, Fla., USA, September, nWater Reuse Association, Paper B4-2 (2012) (“Stover 2012”), and R. L. Stover, “Permeate recovery and flux maximization in semibatch reverse osmosis,” 5 IDA Journal of Desalination and Water Reuse 10-14 (2013) (“Stover 2013”)] that discretizes the CCRO process into stages at different pressures and feed salinities. Table 1, below, shows the comparison between the present CCRO model and that of Stover, using system inputs (shown in table), such as pump efficiency taken from the previous studies. The last two rows show the previous results and the present results for comparison.

TABLE 1
Validation of the present CCRO model against those of Stover:

| Staged model and RR | | |
|---|---|---|
| Stover 2012, | Stover 2012, | Stover 2013, |
| RR = 90% | RR = 95% | RR = 88% |

Inputs

| Feed TDS | 1.8 | g/kg | 1.8 | g/kg | 2.9 | g/kg |
|---|---|---|---|---|---|---|
| RRₘ | 20% | | 20% | | 44% | |
| ΔPₜ | 0.6 | bar | 0.5 | bar | 1.03 | bar |

| | | | |
|---|---|---|---|
| Efficiency of pumps | 70% | 70% | 70% |

Energy consumption

| | | | | | | |
|---|---|---|---|---|---|---|
| Staged model (Stover | 0.41 | kWh/m³ | 0.63 | kWh/m³ | 0.67 | kWh/m³ |
| 2012 and Stover 2013) | | | | | | |
| Present model [Eq. | 0.36 | kWh/m³ | 0.68 | kWh/m³ | 0.59 | kWh/m³ |
| Error! Reference | | | | | | |
| source not | | | | | | |
| found. (22)] | | | | | | |

Although the results would not be expected to be exactly the same due to their different approaches to simplifying the temporal and spatial concentration variations in CCRO, the degree of agreement (within 8-12% for all three comparisons) suggests that the discretization and solution method described herein is reasonable.

Energy consumption calculations presented in the following section are based on a 40% module recovery ratio, hydraulic pressure loss of ΔP₁=1 bar, terminal hydraulic-osmotic pressure difference of ΔPₜ=5 bar, and pump efficiencies of 75%. When relevant, pressure exchanger efficiency is modeled as 96% and energy recovery device efficiency is modeled as 70%.

### Results and Discussion:

### Energy Use:

The energy requirements of all systems modeled herein are compared in this section. FIG. 7 shows energy consumption as a function of recovery ratio for 3 g/kg NaCl feed based on the models in the preceding section. Least work of separation [see G. P. Thiel, E. W. Tow, L. D. Banchik, H. W. Chung, and J. H. Lienhard V, “Energy consumption in desalinating produced water from shale oil and gas extraction,” 366 Desalination 94 -112 (2015)] is also included for comparison.

FIG. 7 plots energy consumption as a function of recovery ratio for reverse osmosis 41, reverse osmosis plus energy recovery 42, CCRO 42, batch plus pressure exchanger 44, and least work 45, showing that the unsteady systems are less energy-intensive than steady RO. At lower recovery, CCRO 43 and batch (plus pressure exchanger) 44 performed very similarly because the entropy generation due to mixing is minimal in both systems. At 80% recovery, however, the batch variant 44 uses about 13% less energy than CCRO 43. As recovery increases to 90%, as it might in the RO step of zero liquid discharge applications, CCRO 43 and batch RO 44 reduce energy use by 31% and 51%, respectively, compared to continuous RO 41. Even with energy recovery 42, continuous RO consumes more energy than the time-variant processes.

Although least work 45 increases monotonically with recovery ratio, FIG. 7 shows that the actual energy consumption of steady RO 41 without energy recovery reaches a minimum around 60% recovery. This trend results from throttling of high pressure brine as it leaves the system. At low recovery ratios, a larger amount of fluid is irreversibly depressurized per unit permeate than at high recovery ratios. While energy recovery devices can replace throttles and recover part of the loss, the unsteady systems reduce energy consumption by only pumping the permeate volume to high pressure, thus eliminating the need to recover energy from the brine. This distinction is discussed further, below.

### System Efficiency Comparison:

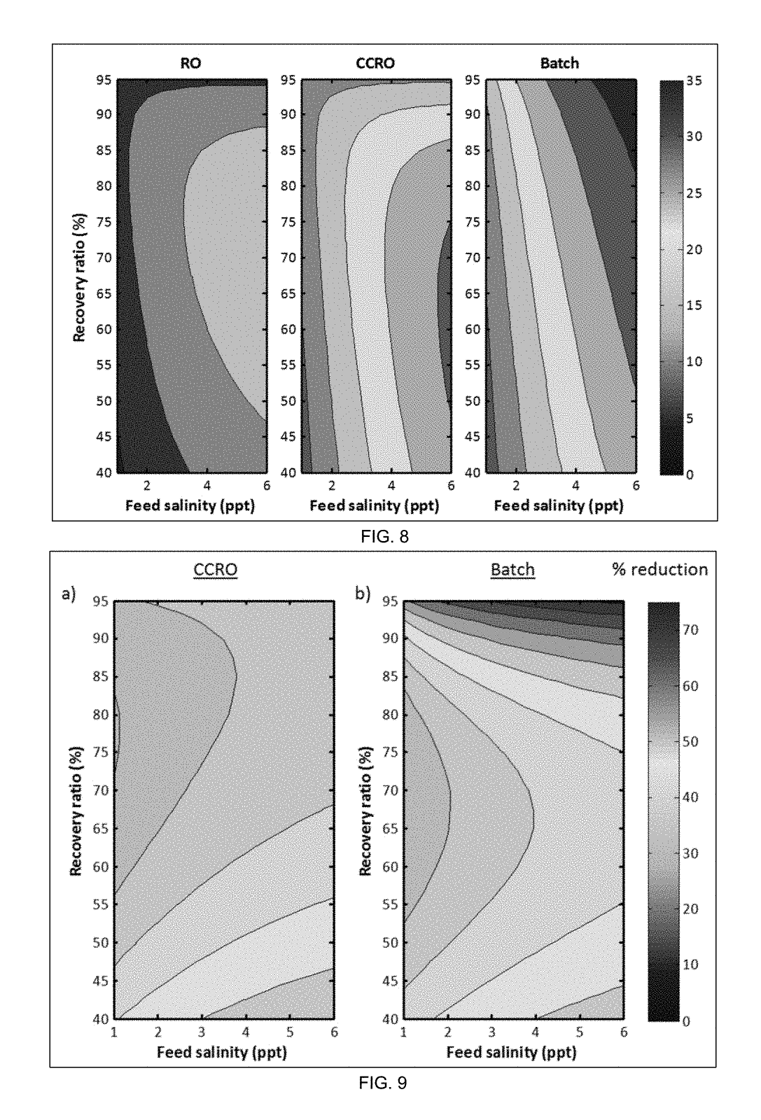

Exergetic efficiencies of steady RO, CCRO, and batch RO are compared to highlight differences between the energy needs of these systems in FIGS. 8 and 9. Exergetic efficiency is defined as the ratio of least work to actual work, where least work is a function of the salinity and recovery ratio as given in G. P. Thiel, E. W. Tow, L. D. Banchik, H. W. Chung, and J. H. Lienhard V, “Energy consumption in desalinating produced water from shale oil and gas extraction,” 366 Desalination, 94-112 (2015). FIG. 8 shows the exergetic efficiency of steady RO without energy recovery, CCRO, and batch RO as a function of salinity and recovery ratio. In FIG. 8, the far upper-right corner represents systems with highly-saline feeds, wherein osmotic pressures are above typical RO operating pressure and actual energy requirements may be outside the applicable range of the present model. The distinctly different shapes of the three efficiency maps demonstrate how different these three process designs are. All three systems have higher efficiency at higher feed salinity because the least work of separation rises while the losses stay relatively fixed, but the effect of recovery varies between them. Steady RO has its highest efficiency at moderately high recovery ratios. CCRO efficiency is relatively insensitive to recovery at low recovery ratios, but then drops sharply at very high recoveries. Only batch systems demonstrate increasing efficiency with increasing recovery across the entire modeled range. At lower recoveries and lower salinities, CCRO and batch RO are nearly identical. As a result, either CCRO or batch RO is an energetically superior choice to steady RO at low recovery, while batch RO is the most efficient of the three systems at very high recovery. FIG. 9 maps these relative advantages over a range of salinities and recovery ratios.

### Sources of Energy Savings:

To explain the differences in system energy consumption and efficiency seen in FIGS. 7 and 8, the drivers of energy consumption are now examined in the systems considered. RO energy consumption is the sum of several contributions, including reversible work, inefficiencies in components such as pumps, irreversible mixing, excess pressure to drive flux, throttling, and viscous friction. For a given feed composition and desired recovery ratio, the reversible work is fixed; and both component efficiencies and viscous friction were kept constant between the different system models in this work. Therefore, the differences in energy consumption come down to three main factors that differ between the system designs, specifically brine throttling, excess pressure, and irreversible mixing.

Continuous RO consumes more energy because of the need to throttle the high pressure brine stream. In continuous RO, the brine leaves continually at high pressure; and, if no energy recovery device is in place, that potentially recoverable energy is lost. This trend is evident in Equation (4) for continuous RO, where the recovery ratio in the denominator leads to high specific energy consumption at low recovery.

Whereas steady RO requires the entire feed volume to be pumped up to high pressure, the CCRO and batch systems only require high-pressure pumping of the permeate volume, leading to significant energy savings, especially at lower recovery. However, the losses from rejecting high-pressure brine unique to continuous RO can be significantly reduced by adding energy recovery to the steady RO system [L. D. Banchik and J. H. Lienhard V, “Thermodynamic analysis of a reverse osmosis desalination system using forward osmosis for energy recovery,” in Proceedings of ASME 2012 International Mechanical Engineering Congress and Exposition, no. IMECE2012-86987, (Houston, Tex.), American Society of Mechanical Engineers (November 2012)], as shown in FIG. 7. Excess pressure above the osmotic pressure also varies between time-variant and steady-state RO systems. In steady-state RO, the pressure is nearly uniform throughout the membrane module (and, in the absence of booster pumps, throughout the train). In batch RO and CCRO, the pressure in the module is roughly uniform at any given time, but it can start low and be continually raised as the osmotic pressure at the module outlet increases. At low recoveries comparable to the module recovery, the excess pressure does not contribute significantly to the difference in energy consumption between technologies, but the effect of this difference rises with increasing recovery.

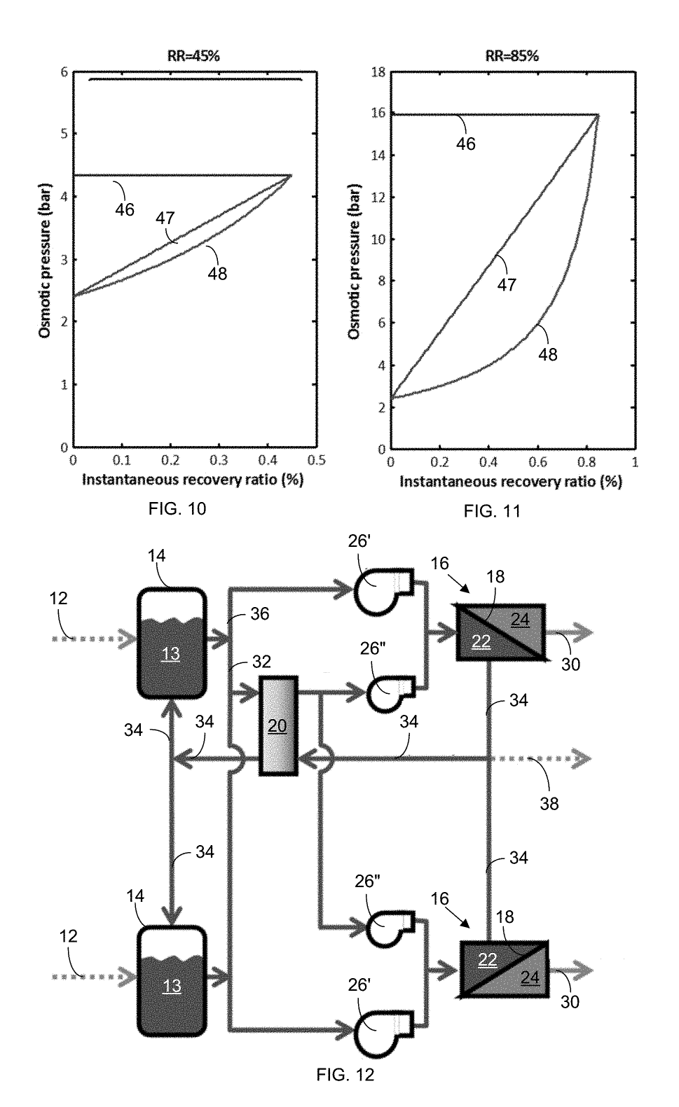

To illustrate this concept, FIGS. 10 and 11 compare the pressure profiles of ideal steady-state RO 46, CCRO 47, and batch 48 systems in the limit of zero membrane resistance, concentration polarization, viscous losses, and module recovery ratio. Whereas the time-variant processes have the ability to stay close to the osmotic pressure curve, the pressure in steady-state RO 46 is maintained at or above the osmotic pressure of the discharged brine everywhere. Between CCRO 47 and batch 48 systems, the shape of the osmotic pressure profiles within a module of finite recovery also contributes to the difference in energy consumption. The osmotic pressure in CCRO 47 rises almost linearly with instantaneous recovery ratio because salt is added to the system constantly with the feed, the flow rate of which matches that of the permeate. As shown previously in FIGS. 5 and 6 and as discussed, above, the variation in osmotic pressure within the RO module is lower for the batch system 48, thereby reducing its energy consumption. In the present comparison, terminal osmotic-hydraulic pressure difference is fixed as a proxy for membrane area, so the differences in energy consumption seen between the steady and transient systems may not be as great at fixed membrane area. However, in a treatise on thermodynamic balancing [G. P. Thiel, R. K. McGovern, S. M. Zubair, and J. H. Lienhard, V, “Thermodynamic equipartition for increased second law efficiency,” 118 Applied Energy 292-299 (2014)], Thiel, et al., show significant energy savings due to a uniform osmotic—hydraulic pressure difference in a batch RO process over a constant-pressure design, even when the area is fixed.

Finally, and most subtly, the energy consumption of the two transient systems is differentiated by the level of irreversible mixing. In the batch process, solution leaving the RO membrane module 16 returns to the reservoir 14 at a concentration higher than the solution in the reservoir 14. When these streams of different concentration mix, entropy is generated and potentially recoverable work is lost. This increases the energy consumption of the system; however, as can be seen from the salinity profiles in FIGS. 5 and 6, the salinity difference between the streams being mixed (the beginning and end of any given salinity curve) is not very large, so the losses due to this mixing process are small. In CCRO, the solution leaving the RO membrane module 16 is mixed not with the reservoir feed 13 but with fresh aqueous source liquid 12. As the salinity in the reservoir 14 is always greater than or equal to the salinity of the aqueous source liquid 12, the entropy generation due to mixing in CCRO is greater than in the batch process. The difference in mixing entropy generation increases with RR, as can be seen from the increase in divergence of the batch and CCRO osmotic pressure profiles in FIGS. 10 and 11 as the recovery ratio is increased from 45% to 85%. This source of energy savings in batch systems 48 over CCRO 47 is reflected in the divergence in energy requirements at high recoveries shown in FIG. 7.

### Use of Multiple Batch Systems:

Multiple batch systems may be combined in several ways. Multiple systems can operate completely in parallel, or they can share various components with the goal of reducing capital cost. In one embodiment, multiple systems share one pressure exchanger 20 (see FIG. 12). Pumps 26 and/or reservoirs 14 can be shared between systems. Multiple RO modules 16 in parallel may share one set of pumps 26, a pressure exchanger 20, and a reservoir 14. Fluid conduits 32, 34, and 36 may be used to connect otherwise-parallel systems at different stages of concentration and/or operating pressure, provided the pressure at the point of convergence is substantially the same (e.g., atmospheric) between the joined systems; and the flow path of a parcel of feed 13 during the process involves flow through an RO module 16, a pressure exchanger 20, a reservoir 14, and a pressure exchanger or high pressure pump 26, and an RO module 16 again, etc., in this order until it is released as permeate or brine. One potential advantage of adding fluid conduits between systems operating under different conditions (e.g., at different stages of concentration) is to reduce entropy generation due to mixing or due to the use of low-efficiency components, such as booster pumps 26″, e.g., by passing the RO concentrate 34 at a higher salinity (i.e., at a later stage of concentration) through the pressure exchanger 20 of another system at an earlier stage of concentration to reduce the pressure increase required by its booster pump 26″ or to eliminate the need for a booster pump 26″.

One such example utilizes two different RO module chains with significantly different pressure drops. This configuration may be utilized if different types of RO modules 16 are being used (where channel widths, for example, vary substantially enough to impact pressure drop) or if some RO modules 16 have turbulators (to increase mass transfer coefficients). Spacer differences can also play a role. As shown in FIG. 12, the pressure will be the same where streams mix; but the pressure before the RO modules 16 can differ, which can control flux flexibly for the RO module chains with different hydraulics.

### Conclusions:

The following conclusions were reached from the study described herein. First, batch RO and CCRO have substantial fundamental efficiency improvements over continuous RO, especially at low (<50%) and high (>75%) recoveries and higher salinities. Second, the efficiencies of batch RO and CCRO diverge sharply at high recovery, due to the fact that CCRO continuously dilutes the recirculating stream with feed, which generates entropy. Third, the fouling resistance of CCRO (and, hypothetically, batch RO) can be explained by residence times three orders of magnitude shorter than seen in continuous RO.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, 1/15^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention. In method claims (or where methods are elsewhere recited), where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A method for batch pressure-driven liquid separation, comprising:
a) flowing a source liquid including a solvent with a dissolved impurity into a reservoir;
b) pumping a feed of at least one of the source liquid and a concentration of the source liquid from the reservoir through a pressure exchanger into an upstream side of a liquid separation module, wherein the liquid separation module comprises a membrane that passes at least partially purified solvent as filtrate to a permeate side of the liquid-separation module while diverting the impurity in a feed retentate on the upstream side of the liquid-separation module;
c) extracting the purified solvent from the permeate side of the liquid-separation module;
d) passing the feed retentate from the upstream side of the liquid-separation module through the pressure exchanger, where pressure from the feed retentate is transferred to the feed leaving the reservoir;
e) passing the feed retentate from the pressure exchanger to the reservoir;
f) recirculating the feed retentate as a component of the feed via steps (b)-(e), wherein concentration of the impurity in the feed and pressure in the upstream side of the liquid-separation module increases and volume of feed in the reservoir decreases with each iteration of steps (b)-(e); and
g) after a plurality of simultaneous iterations through steps (b)-(e), discharging a concentrated impurity stream from the liquid-separation module and, at the same time, supplying new source liquid to the reservoir.

2. The method of claim 1, wherein only a first portion of the feed pumped from the reservoir is passed through the pressure exchanger.

3. The method of claim 2, further comprising pumping a second portion of the feed into the upstream side of the liquid-separation module without passing through the pressure exchanger.

4. The method of claim 1, wherein the feed is stored in the reservoir at a pressure that is substantially the same as ambient atmospheric pressure.

5. The method of claim 4, wherein the liquid-separation module exhibits a pressure drop of at least about 1 kPa across the membrane.

6. The method of claim 1, wherein the source liquid flows into the reservoir only before feed has flowed through the first iteration of steps (b)-(e) in a span from before the first iteration of steps (b)-(e) up through the extraction of the brine residue.

7. The method of claim 1, further comprising temporarily reducing system pressure after feed flows through at least one iteration of steps (b)-(e) and allowing solvent from the permeate side of the liquid-separation module to flow through the membrane to backwash the membrane.

8. The method of claim 1, wherein feed flows continuously and simultaneously through steps (b)-(e).

9. The method of claim 1, further comprising increasing cross-sectional flow area for the retentate through the pressure exchanger as pressure in the upstream side of the liquid-separation module increases.

10. The method of claim 1, further comprising using a plurality of staged liquid-separation modules, wherein retentate from a preceding liquid-separation module is fed to a subsequent liquid-separation module as the feed in the subsequent liquid-separation module, and wherein the retentate from the subsequent liquid-separation module is passed through the same pressure exchanger as the feed from a preceding liquid-separation module.

11. The method of claim 1, further comprising pumping feed through a plurality of liquid-separation modules, wherein the feed pumped into the liquid-separation modules and the feed retentate diverted from the liquid-separation modules are all passed through the same pressure exchanger.

12. The method of claim 11, wherein a plurality of reservoirs respectively supply feed to the liquid-separation modules and receive feed retentate from the liquid-separation modules.

13. The method of claim 11, wherein the liquid-separation modules operate in parallel.

14. The method of claim 11, wherein the liquid-separation modules operate with different pressure drops across the membranes.

15. The method of claim 1, wherein the solvent comprises water, and wherein the impurity comprises salt.

16. The method of claim 15, wherein the liquid-separation module is a reverse-osmosis module.

17. A batch pressure-driven membrane desalination system, comprising:
a reservoir for containing a feed liquid and including an outlet and an inlet for a supply of recirculated retentate;
a pressure exchanger;
a liquid-separation module including an inlet, a membrane that passes solvent as a filtrate to a permeate side of the liquid-separation module while retaining dissolved impurities in a concentration of the feed liquid as retentate in an upstream side of the liquid-separation module, a concentrated-feed outlet positioned to extract the retentate from the permeate side; and a solvent outlet configured to extract the filtrate from the upstream side;
a first conduit coupling the reservoir with the liquid-separation module and providing fluid communication therebetween and providing passage through the pressure exchanger;
a pump configured to pump feed liquid from the reservoir into the liquid-separation module; and
a second conduit coupling and providing fluid communication between the concentrated-feed outlet of the liquid-separation module with the reservoir and providing passage through the pressure exchanger.

18. The batch pressure-driven membrane desalination system of claim 17, wherein the reservoir is unsealed.

19. The batch pressure-driven membrane desalination system of claim 17, further comprising a third conduit coupling the outlet of the reservoir with the liquid-separation module and providing fluid communication therebetween without providing a passage through the pressure exchanger.

20. The batch pressure-driven membrane desalination system of claim 19, further comprising a second pump configured to pump feed liquid from the reservoir through the third conduit to the liquid-separation module.

21. The batch pressure-driven membrane desalination system of claim 17, wherein the reservoir further comprises a source inlet coupled in fluid communication with a source of the feed liquid.

22. The batch pressure-driven membrane desalination system of claim 17, further comprising a concentrated impurity outlet in fluid communication with the upstream side of the liquid-separation module for removing a brine residue from the liquid-separation module.
